(19) United States
(12) Patent Application Publication
(10) Pub. No.: US 2025/0317067 A1
(43) Pub. Date: Oct. 9, 2025

(54) DC-DC CONVERTER WITH BYPASS CONNECTION

(71) Applicant: SEMICONDUCTOR COMPONENTS INDUSTRIES, LLC, Scottsdale, AZ (US)

(72) Inventor: Daniel Leon GOLDMANN, Munich (DE)

(73) Assignee: SEMICONDUCTOR COMPONENTS INDUSTRIES, LLC, Scottsdale, AZ (US)

(21) Appl. No.: 18/626,891

(22) Filed: Apr. 4, 2024

(51) Int. Cl. H02M 3/335; H02J 7/00; H02M 3/00

(52) U.S. Cl. CPC H02M 3/33573; H02J 7/007; H02M 3/01; H02M 3/33576; H02J 2207/20

(57) ABSTRACT

A direct current-to-direct current (DC-DC) converter includes an output node that is connectable to a battery pack, a first set of power switches, an isolation circuit, and a second set of power switches connected to the isolation circuit. The second set of power switches is arranged in three switching pairs. The second and third switching pairs are connected in parallel, with the third switching pair connected to the output node. A boost capacitor is arranged in parallel with the second and third switching pairs. A bypass connection connects a power switch of the first switching pair directly to the output node.

### TECHNICAL FIELD

The present disclosure relates to electrical circuit topologies and control methods for performing a direct current-to-direct current conversion process.

### INTRODUCTION

Electric vehicles, standby power supplies, power stations, and other mobile and stationary battery electric systems utilize a rechargeable battery pack as a direct current (DC) energy storage device. An offboard charging station may be used to recharge constituent electrochemical battery cells of the battery pack when the cells become depleted. For battery packs having relatively high voltage capabilities, for instance 400-800 volt (V) traction battery packs used to energize one or more alternating current (AC) traction motors onboard a mobile system, rapid battery charging may be achieved via a direct current fast charging (DCFC) process. The relatively high charging power during a DCFC session allows a battery charging event to be completed in significantly less time relative to AC-based “Level 1” or “Level 2” charging.

A typical DCFC charging station uses a voltage rectifier connected to AC grid power for converting an AC input waveform into a DC output waveform and provide necessary power factor correction. A direct current-to-direct current (DC-DC) converter receives an input voltage from the voltage rectifier and outputs a required charging current to a connected battery pack. A given charging station may be used to charge a population of traction battery packs having different voltage capabilities. As a result, high-voltage charging solutions at 50-300 kilowatts or more are often required to efficiently charge battery packs at the varying battery voltage capabilities.

### SUMMARY

A direct current-to-direct current (DC-DC) converter is described herein, along with electrical circuits and charging stations using the DC-DC converter. The need to efficiently charge battery packs of varying battery voltage capabilities may be addressed by constructing the DC-DC converter in accordance with the present disclosure. In particular, the contemplated converter topology incorporates switching hardware circuits with multiple switching pairs and a bypass connection. The bypass connection connects a semiconductor-based power switch of one of the switching pairs directly to the charging battery pack

The DC-DC converter may be constructed from multiple switching pairs, which in some implementations may be packaged in separate power modules. The converter may include a dual active bridge (DAB) configuration (i.e., a supply-side bridge and a battery-side bridge) and an inductor-capacitor (LC) circuit. While the disclosed converter may be bi-directional in its design, in certain implementations, such as when charging a propulsion battery pack of an electric vehicle, circuit components of the converter may be used to situationally boost the charging voltage to a consistently high voltage level needed for charging the connected battery pack.

To reduce losses associated with voltage boosting, the converter in the embodiments described herein includes the above-noted bypass connection, i.e., an electrically conductive wire or trace. The bypass connection in one or more implementations directly connects a switch of the battery-side bridge to the battery pack. Use of the bypass connection as described in detail herein thus enables voltage boosting while reducing a required charging current to the battery pack.

An embodiment of the DC-DC converter includes an output node connectable to a battery pack, a first set of power switches, an isolation circuit, and
a second set of power switches. The power switches of the second set are connected to the isolation circuit and arranged in three switching pairs. The three switching pairs. Second and third switching pairs of the three switching pairs are connected in parallel, with the third switching pair connected to the output node. A boost capacitor is arranged in parallel with the second and third switching pairs. The bypass connection connects a power switch of the first switching pair directly to the output node. The above summary is not intended to represent every embodiment or aspect of the present disclosure. Rather, the foregoing summary exemplifies certain novel aspects and features as set forth herein. The above noted and other features and advantages of the present disclosure will be readily apparent from the following detailed description of representative embodiments and modes for carrying out the present disclosure when taken in connection with the accompanying drawings and the appended claims.

### BRIEF DESCRIPTION OF THE DRAWINGS

The drawings described herein are for illustrative purposes only, are schematic in nature, and are intended to be exemplary rather than to limit the scope of the disclosure.

FIG. 1 is a schematic diagram of an electrical system having a direct current-to-direct current (DC-DC) converter with a bypass connection constructed in accordance with the present disclosure.

FIG. 1A is a schematic diagram of the DC-DC converter of FIG. 1 according to an alternative construction.

FIG. 2A is a representative time plot of a middle voltage in a first stage of the exemplary DC-DC converter illustrated in FIG. 1.

FIG. 2B is a representative time plot of an output current and a boost current of the DC-DC converter illustrated in FIG. 1.

FIG. 2C is a representative time plot of a primary transformer current of the first stage of the DC-DC converter illustrated in FIG. 1.

FIG. 3A is a representative time plot of the middle voltage of FIG. 2A over a shorter time interval.

FIG. 3B is a representative time plot of an output current and a boost current of FIG. 2B over a shorter time interval.

FIG. 3C is a representative time plot of a primary transformer current of FIG. 2C over a shorter time interval.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

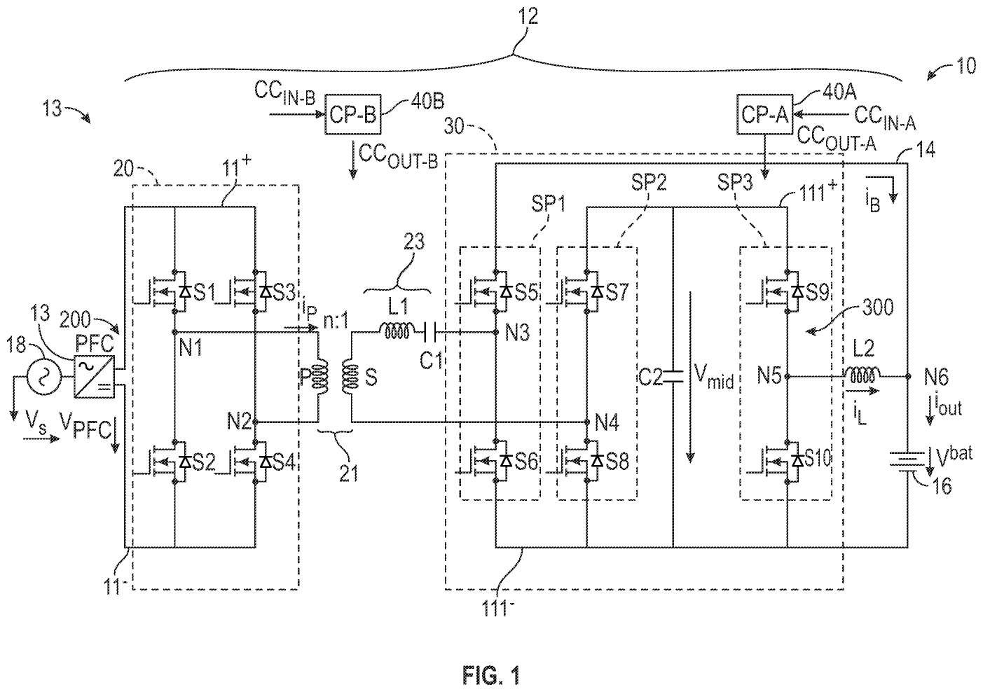

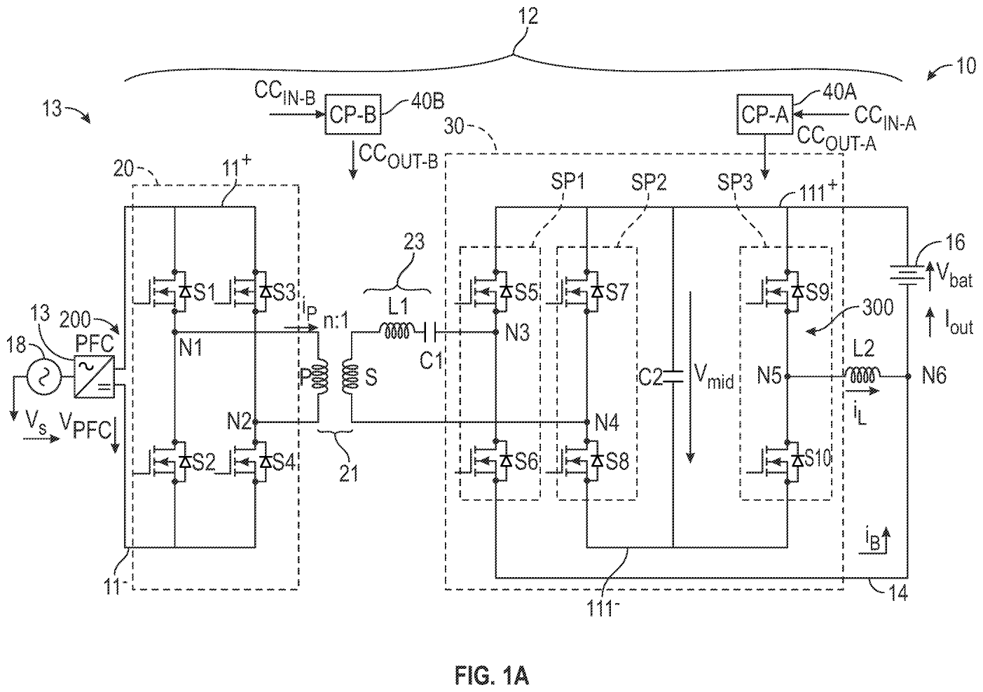

With reference to the drawings, wherein like reference numbers refer to the same or similar components throughout the several views, an electrical circuit 10 is illustrated in FIG. 1 having a direct current-to-direct current (DC-DC) converter 12, a voltage rectifier 13, and respective first and second inductors L1 and L2. The electrical circuit 10 in a non-limiting scenario is operable for charging a rechargeable battery pack 16 after first converting an alternating current (AC) source voltage (V_{PFC}) from an AC power supply 18. The converter 12 as described in detail herein is configured to connect to the battery pack 16 via the inductor L2, shown at far right in FIG. 1, at an output node N6 during a direct current fast charging (DCFC) process. The inductor L2 and output node N6 may be incorporated into a charging cord set/charge connector of an electric vehicle supply equipment (EVSE) charging station.

When charging the connected battery pack 16, the DC-DC conversion process may be performed using the DC-DC converter 12 of FIG. 1 to enable reduced current and a wide output voltage range during charging operations, with minimal electrical losses. The converter 12 described herein foregoes use of a voltage-reducing buck stage, instead incorporating a bypass connection 14 around circuit components used for performing a boost function. The bypass connection 14 directly connects one of three switching pairs (SP1, SP2, SP3) of the converter 12, in particular a first switching pair SP1, to the battery pack 16 via the output node N6 (shown at far right in FIG. 1). Use of the illustrated bypass connection 14 also has the benefit of decreasing current flow during boost operations, thereby increasing operating efficiency of the converter 12.

In the representative circuit topologies of FIG. 1, the battery pack 16 may be alternatively embodied as a lithium-ion, nickel-metal hydride (NiMH), nickel-cadmium (NiCd), or another application-suitable battery chemistry. For instance, the battery pack 16 may be configured as a high-voltage rechargeable battery pack for powering an electric vehicle or a stationary power plant, or as a standby energy supply for a residential or commercial building. In one or more implementations, “high-voltage” refers to about 400-800V or 1000V or more, without limitation.

The DC-DC converter 12 may be connected to the AC power supply 18, e.g., grid power, via the voltage rectifier 13. That is, the voltage rectifier 13 may be connected to the AC power supply 18 to receive an AC input waveform therefrom, with the voltage rectifier 13 outputting a DC voltage waveform as an input voltage (V_{PFC}) to the DC-DC converter 12. Although shown schematically for illustrative simplicity, the voltage rectifier 13 may be configured to provide power factor correction (PFC) as needed.

Components of the DC-DC converter 12 of FIG. 1 may be packaged as first and second power modules 20 and 30 in one or more embodiments. “Module” in such an instance may include the illustrated hardware components, and possibly a protective outer housing (not shown) to protect such components from moisture and debris. The second power module 30 may be connected to the first power module 20 and configured to boost an output voltage level thereof. An input side 200 of the first power module 20 is connected to the voltage rectifier 13. Additionally, the first power module 20 may be isolated from the second power module 30 by an intervening n:1 transformer 21, where n is the ratio of turns of the primary (P) and secondary(S) windings of the transformer 21. In some implementations, the transformer 21 may be constructed as a 1:1 transformer, i.e., n=1, without limiting the disclosure to such an embodiment.

Still referring to FIG. 1, the DC-DC converter 12 includes a plurality of semiconductor-based power switches. The exemplary first power module 20 in particular may include a first set of power switches (S1, S2, S3, and S4) arranged as a supply-side bridge as shown. A second set of power switches, i.e., six power switches S5, S6, S7, S8, S9, and S10 arranged in the above-noted three switching pairs SP1, SP2, and SP3 are hardware components of the second power module 30 as described below. In various embodiments, the various power switches S1-S6 may be constructed as silicon-based or silicon carbide-based metal-oxide semiconductor field effect transistors (MOSFETs), silicon-based insulated gate bipolar transistors (IGBTs), or wide-bandgap (WBG) gallium nitride (GaN) switches, by way of example and not of limitation.

The present teachings allow for an increased middle voltage (V_{mid}) between a positive rail 111⁺ and a negative rail 111⁻. Thus, a voltage rating of the individual switches of switching pair SP2 and SP3 connected across the positive and negative voltage rails 111⁺, 111⁻, i.e., power switches S7, S8, S9, and S10 in the representative circuit topology of FIG. 1, exceeds a voltage rating of power switches S5 and S6 of the remaining one of the three switching pair, i.e., the switching pair SP1. For instance, the voltage rating of the power switches S7, S8, S9, and S10 of the switching pairs SP2 and SP3 in a possible implementation may be at least about 800V to about 1000V. However, the actual voltage rating will depend on the particular voltages and currents of the implemented electrical circuit 10. For this reason, the power switches S7, S8, S9, and S10 when constructed as power switches may benefit from construction from silicon carbide (SiC) materials, e.g., as SiC MOSFETs in a possible non-limiting implementation.

The power switches S1-S4 of the DC-DC converter 12 may be arranged as an H-bridge. As appreciated in the art, the H-bridge typically consists of four switching elements, such as MOSFETs a shown, transistors, or other suitable switching elements, which are arranged in a bridge configuration with a load connected between two central nodes (N1, N2) of the H-bridge. The power switches S1 and S3 are electrically connected to a positive voltage rail 11⁺ of the converter 12, and thus function as nominal “upper” switches in the electrical circuit 10. The power switches S2 and S4 are electrically connected to a negative voltage rail 11⁻, i.e., electrical ground, and thus function as nominal “lower” switches, i.e., with “upper” and “lower” respectively describing the positive and negative voltage rail connections.

The power switches (S1, S2) are connected at node N1. Similarly, the power switches (S3, S4) are connected at node N2. Nodes N1 and N2 in turn connect to opposing ends of the primary winding (P) of the transformer 21 to drive an isolation circuit 23, shown in FIG. 1 as a non-limiting LC circuit represented as a first inductor L1 and a first capacitor C1. In the illustrated configuration, the LC circuit embodiment of the isolation circuit 23 is not operated close to its resonant frequency. Here, power may be converted via a phase-shift operation.

As appreciated in the art, phase-shift control (change in the relative timing or position of a waveform or signal compared to a reference signal or waveform) and frequency control (varying a switching frequency relative to the resonant frequency of the LC circuit) are used in the control of LC circuits for efficient power transformation. That is, when regulating an output voltage or current, it is possible to adjust the voltage-current waveform phase or frequency relationship. An LC circuit in particular, such as the isolation circuit 23 shown in FIG. 1, exhibits a phase shift due to properties of the first inductor (L1) and the first capacitor (C1). This phase shift may be exploited by the control processor 40B to control energy transfer to the switching pairs (SP1, SP2, SP3) when energizing downstream circuit components of the DC-DC converter 12. The first capacitor C1 in the non-limiting topology of FIG. 1 may be used to block a DC voltage that would otherwise be applied as a consequence of different voltages as described below. Without the first capacitor C1, in other words, a DC voltage would be applied to the transformer 21, which in turn may lead to saturation of the core material in the event of an electrical short. Other configurations may be contemplated within the scope of the disclosure, e.g., as a resonant converter using frequency modulation, and thus phase-shift control of the circuit 23 is just one possible implementation.

Still referring to FIG. 1, the three switching pairs SP1, SP2, and SP3, which collectively include power switches S5-S10, are connected to the secondary winding(S) of the transformer 21 via the intervening isolation circuit 23. In the illustrated arrangement, the power switches (S5, S6) forming the first switching pair SP1 are connected together at node N3. Similarly, the power switches (S7, S8) forming the second switching pair SP2 are connected at node N4. The power switches (S9, S10) in turn forms the third switching pair SP3, with power switches S9 and S10 being connected together at node N5. Node N3 for its part is connected to the isolation circuit 23 in this embodiment, with node N4 connected to the secondary winding(S) of transformer 21.

The third switching pair SP3 of FIG. 1 is arranged in parallel with the second switching pair SP2 to form a boost stage of the DC-DC converter 12, with the switching pairs SP2 and SP3 being connected to the second capacitor C2 (hereinafter referred to as the boost capacitor C2) via the respective positive and negative voltage rails 111⁺ and 111⁻. The boost capacitor C2, which is arranged in parallel with the switching pairs SP2 and SP3, carries the boosted middle voltage (V_{mid}). The switching pair SP3 is directly connected to the output node N6. Node N5 disposed at output side 300 of the second power module 30 is connectable to the battery pack 16 via the boost inductor L2 during a DCFC charging even. The connection of node N5 to the battery pack 16 is made via the output node N6. Output node N6 in one or more implementations may be a charge connection point of an EVSE charging station using the DC-DC converter 12, for instance a charge coupler (not shown) thereof.

As shown in FIG. 1, in a representative charging operation the connected battery pack 16 at battery voltage level (Vₐₜ) receives a charging output current (iₒᵤₜ) from the output node N6. The output current (iₒᵤₜ) in this topology is the sum of a boost current (i_{L}) passing through the second inductor L2 and a bypass current (i_{B}), the latter of which passes around the boost stage (switching pairs SP2 and SP3) via the bypass connection 14. That is, the switching pair SP1 is directly connected to the battery pack 16 via the output node N6 and the bypass connection 14, i.e., in lieu of connecting the power switch S5 to the positive voltage rail 111⁺. The topology of FIG. 1 is thus intended to provide an increased voltage during a boost stage of operation with increased charging efficiency without requiring additional hardware or circuit complexity.

As noted above, the four power switches S1-S4 and four of the six remaining power switches S5-S10, together form a dual active bridge (DAB) having a total of eight power switches (i.e., S1-S8). The power switches S1-S4 are arranged to form a supply-side bridge. Switches S5-S8 are arranged in this embodiment to form a battery-side bridge, with the terms “supply-side” and “battery-side” indicating relative proximity to the AC power supply 18 and the battery pack 16, respectively. In the contemplated embodiments, only one switching pair of the battery-side bridge—i.e., the second switching pair SP2—is boosted to a higher voltage. The second and third switching pairs SP2 and SP3 together output an average voltage across the boost capacitor C2 as shown, thus forming the middle voltage (V_{mid}).

Boost operation using the DC-DC converter 12 of FIG. 1 involves a controlled operation of the power switches S1-S4, the transformer 21, the isolation circuit 23, and the first and second switching pairs SP1 and SP2 of (specifically the switches S5-S8). The first capacitor C1 of isolation circuit 23 as noted above blocks any DC offset between the two switching pairs SP2 and SP3, essentially averaging the applied voltages as the boosted middle voltage (V_{mid}).

Referring briefly to FIG. 1A, skilled artisans will appreciate that the bypass connection 14 of FIG. 1 may extend between the switch S6 and the output node N6. The battery pack 16 in such an embodiment is connected to the positive voltage rail 111⁺ and the output node N6. In effect, the solution of FIG. 1A replaces a common ground of FIG. 1 with a common positive voltage rail 111⁺.

Control Loops: Control of the representative DC-DC converter 12 of FIG. 1 may occur in two dynamically decoupled control loops whose operation is independently regulated by a specific controller, i.e., first or second control processors 40A (CP-A) or 40B (CP-B), e.g., microprocessors, central processing units, or integrated circuits programmed and thus operable to control the functions of the electrical circuit 10 described herein. The respective first and second control processors 40A and 40B or another plurality of control processors may receive input signals (CC_{IN-A}, CC_{IN-B}) in the form of, e.g., the reported battery voltage (V_{bat}), the source voltage (V_{PFC}), ON/OFF conductive states of the various power switches (S1-S10), temperature, etc.

In response to the input signals (CC_{IN-A}, CC_{IN-B}), the respective first and second control processors 40A and 40B are configured to output corresponding control signals (CC_{OUT-A}, CC_{OUT-B}) to the various switches to control power flow across the electrical circuit 10 as needed and independently control an ON/OFF conducting state of different sets of the power switches, e.g., with power switches S9 and S10 controlled by the second control processor 40B to control the boost voltage (middle voltage V_{mid}) and the remaining power switches S1-S8 controlled via the first control processor 40A to control power flow.

Using respective control processes, the first control processor 40A is operable to control a corresponding ON/OFF conductive state of the eight power switches S1-S8 and a state of the isolation circuit 23. That is, the first control processor 40A may be used to help control power flow over the isolated converter via state control over the various power switches S1, S2, S3, S4, S5, S6, S7, and S8. In one or more implementations, the first control processor 40A may control the dual active bridge (DAB), i.e., the power switches forming the supply-side and battery-side bridges noted above, via single phase-shift control as a possible first process. As appreciated by those skilled in the art, this entails dynamically changing a phase angle to control power flow on the transmission line, e.g., using a tap to introduce a controllable voltage via the secondary winding into the magnetic circuit of the transformer 21.

Power flow across the isolation circuit 23 may be achieved via variable frequency control as a second process, with other possible approaches possibly used within the scope of the disclosure. As appreciated by those skilled in the art, power flow in an LC circuit is determined by the circuit's impedance. The impedance in turn is a function of the frequency of an applied voltage (or current). This, the frequency of the applied signal can be varied to change the impedance of the LC circuit. In a resonant converter, the switching frequency may be varied around a resonant frequency of the LC circuit to control power flow and regulate output voltage. Thus, implementing variable frequency control in the DC-DC converter 12 may include using a feedback control loop to monitor output voltage and adjust the input frequency.

A second boost loop controlled via the second control processor (CP-B) 40B may be used to control the middle voltage (V_{mid}), which may occur by changing the duty cycle of the switches (S9, S10) of the third switching pair SP3. As used herein, duty cycle (stated as a percentage or ration of between 0 and 1) is the time a switch is in an on/conducting state compared to the time the same switch is turned off/not conducting. Thus, 0% duty cycle is always off and 100% duty cycle is always on. In the context of the DC-DC converter 12, duty cycle variation may be used, for instance, by changing the ratio of the switch S10 being on/switch S9 being off, and vice versa.

To this end, the middle voltage (V_{mid}) may be set by the second control processor 40B in accordance with the following equation:

$${V}_{mid} = 2 {V}_{PFC} - {V}_{bat}$$

where V_{PFC} is the source voltage from the voltage rectifier 13 and V_{bat} is the voltage capability (“battery voltage”) of the battery pack 16. Thus, the middle voltage (V_{mid}) may be determined as a function of the supply voltage (V_{PFC}) and the battery voltage (V_{bat}) of the battery pack 16. If V_{bat} exceeds V_{PFC}, then the second control processor 40B may leave power switch S9 in an ON state, i.e., a conducting state, thus resulting in the middle voltage V_{mid} being equal to the battery voltage V_{bat}.

In the present approach, the middle voltage V_{mid} can be set much higher than it ordinarily would be in a conventional two-stage converter. For instance, in some implementations the middle voltage V_{mid} may be set about 30-35% higher in a non-limiting example 100 kW charging event from a 700V input, using a 1:1 transformer 21, for a battery pack 16 at 450V and a boost voltage (V_{mid}) of 950V. The relatively high middle voltage (V_{mid}) helps reduce losses in the converter 12, albeit at the expense of requiring the power switches S7, S8, S9, and S10 to be rated for the higher voltage. High-voltage embodiments of the battery pack 16 (e.g., 700V to 800V or more) can be charged with the power switch S9 constantly on/conducting due to the 1:1 construction of the transformer 21, with only half of the battery current flowing through the power switch S9 in this case. That is, in the event the supply voltage (V_{PFC}) is approximately equal to or exceeds the battery voltage (V_{bat}), nothing would occur during boost, with the bypass connection 14 in this event ensuring that only 50% of the charging power is transferred over the inactive switching components.

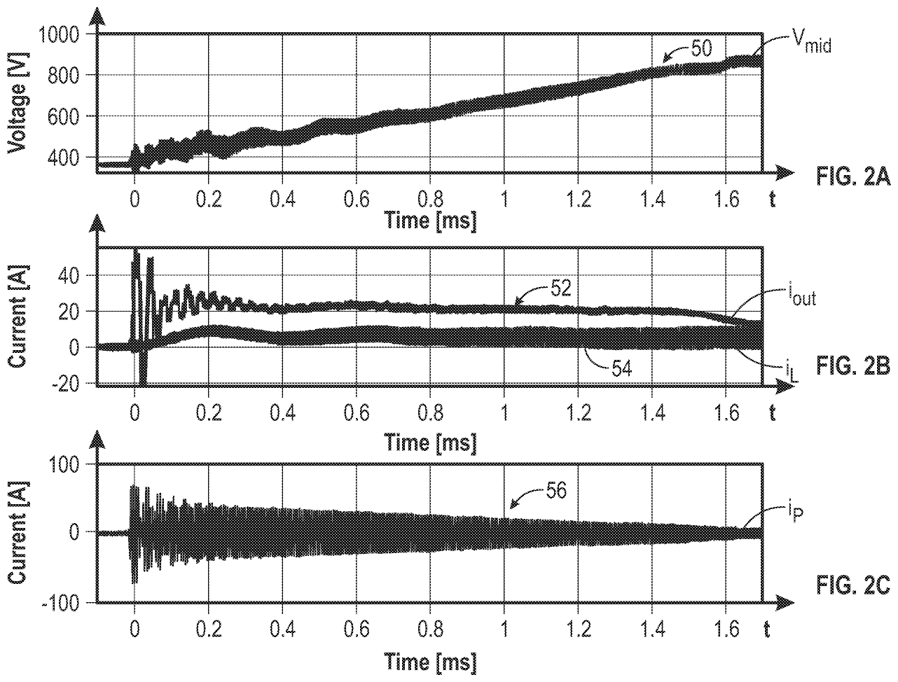

Referring now to FIGS. 2A, 2B, and 2C, operation of the DC-DC converter 12 of FIG. 1 is illustrated via traces 50, 52, 54, and 56 over a representative time interval, where time (t) is represented in milliseconds (ms). In this example, DAB control and boost control both commence at t=0 and continue until about t=1.6 ms, after which the DC-DC converter 12 is controlled to steady-state operation. That is, trace 50 of FIG. 2A represents a possible trajectory of the middle voltage (V_{mid}) starting at about 400V and continuing until V_{mid}=860V in this non-limiting exemplary case.

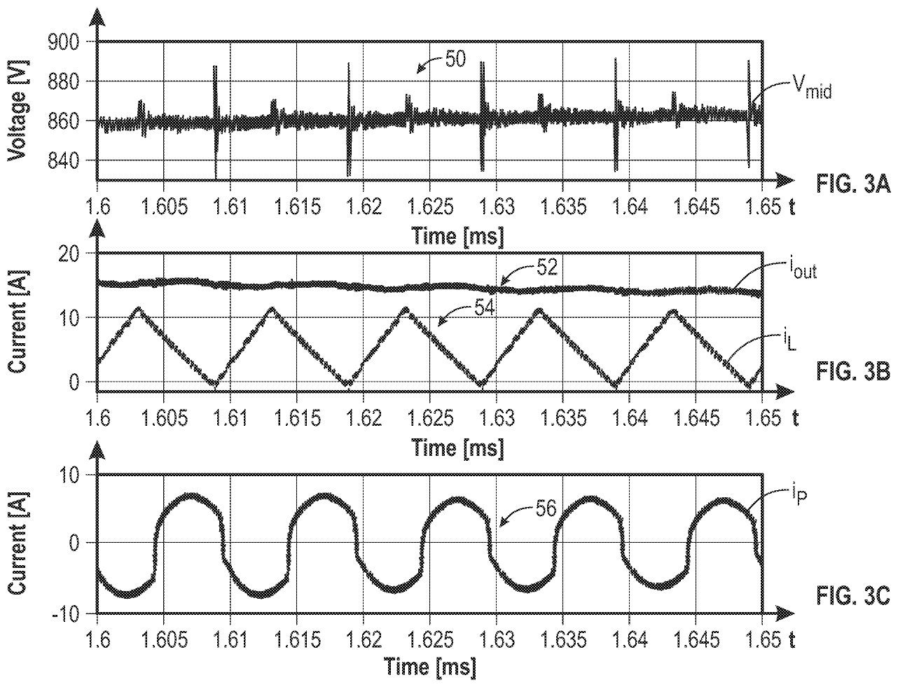

Traces 52 and 54 of FIG. 2B illustrate the output current (iₒᵤₜ) and the boost current (i_{L}), respectively, the locations of which are depicted in FIG. 1. In this example, oscillations in the output current (iₒᵤₜ) from t=0 until about t=0.4 ms are quickly reduced during the boost stage, eventually settling to a relatively steady state value of about 15 A by the completion of the boost stage at t=1.6 ms. At this time, the boost current (i_{L}) continues to vary as a sawtooth/triangle wave (see FIG. 3B), in this instance between about 0 A to about 10 A. Over the same boost interval, the primary current (Iₚ) to the primary winding (P) of transformer 21 of FIG. 1 gradually reduces to a smooth, well-defined oscillation range, which in this exemplary case is about ±8 A (see FIG. 3C). Note that the boost current (i_{L}) is smaller than the output current (iₒᵤₜ), indicating that the bypass connection 14 effectively reduces current flow through the respective second and third switching pairs SP2 and SP3.

FIGS. 3A, 3B, and 3C correspond to FIGS. 2A, 2B, and 2C, respectively, over a representative shorter time interval of 1.6 ms to 1.65 ms to better illustrate the trajectories of traces 50, 52, 54, and 56 of FIGS. 2A-2C, and continues beyond the boost stage to further illustrate steady state operation. After completion of the boost stage, the boosted middle voltage (V_{mid}) oscillates within a narrow window about its average value, in this representative case about 860V, to provide a continuous output voltage for charging the connected battery pack 16 of FIG. 1. Likewise, the steady state nature of the output current (iₒᵤₜ) is shown in trace 52 of FIG. 3B, with the boost current (i_{L}) remaining well below the output current (iₒᵤₜ) of trace 54 and the boost current (i_{L}) providing the remaining portion of the output current (iₒᵤₜ). Trace 56 of FIG. 3C for its part presents the primary current (i_{P}) to the transformer 21 of FIG. 1 as a smooth, approximately sinusoidal waveform, which is representative of reduced losses and increased efficiency.

Thus, use of the bypass connection 14 extending from the power switching pair SP1 to the output node N6 enables boosting to a high voltage with reduced current flow over the boost stage. Possible attendant benefits of the foregoing teachings include an increase in efficiency of stationary EV chargers required to charge battery packs 16 having different voltage capabilities, e.g., about 400V-800V or more, as well as a wide range of other applications utilizing boosted power supplies and power plants. Among other possible users, providers of EVSE stations needing to support many different battery voltage levels may benefit from the alternative circuit topology of FIG. 1.

While several modes for carrying out the many aspects of the present teachings have been described in detail, those familiar with the art to which these teachings relate will recognize various alternative aspects for practicing the present teachings that are within the scope of the appended claims. The above description and accompanying drawings are illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments. Moreover, the present concepts expressly include combinations and sub-combinations of the described elements and features. The detailed description and the drawings are supportive and descriptive of the present teachings, with the scope of the present teachings defined solely by the claims.

What is claimed is:

1. A direct current-to-direct current (DC-DC) converter comprising:
an output node connectable to a battery pack;
a first set of power switches;
an isolation circuit; and
a second set of power switches connected to the isolation circuit and arranged in three switching pairs, the three switching pairs including a first switching pair, a second switching pair, and a third switching pair, wherein the second switching pair and the third switching pair are connected in parallel, and wherein the third switching pair is connected to the output node;
a boost capacitor arranged in parallel with the second switching pair and the third switching pair; and
a bypass connection that connects a power switch of the first switching pair directly to the output node.

2. The converter of claim 1, wherein the isolation circuit includes an inductor-capacitor (LC) circuit.

3. The converter of claim 1, wherein:
the first set of power switches includes four power switches arranged to form an H-bridge; and
the four power switches of the first set of power switches and four of the power switches of the second set of power switches together form a dual active bridge (DAB) having eight power switches.

4. The converter of claim 3, further comprising:
a control processor operable to control a corresponding conductive state of the eight power switches and a state of the isolation circuit using respective control processes.

5. The converter of claim 4, wherein the respective control processes include single phase-shift control and variable frequency control.

6. The converter of claim 1, wherein a voltage rating of the switches of the second switching pair and the third switching pair exceeds a voltage rating of the power switches of the first switching pair.

7. The converter of claim 6, wherein the voltage rating of the power switches of the second switching pair and the third switching pair is at least about 900 volts.

8. The converter of claim 1, wherein the power switches of the second switching pair and the third switching pair are silicon carbide (SiC) switches.

9. The converter of claim 8, wherein the SiC switches include SiC metal oxide silicon field effect transistors (MOSFETs).

10. The converter of claim 1, further comprising:
a control processor operable to change a duty cycle of the power switches of the second switching pair and the third switching pair.

11. The converter of claim 10, wherein the control processor operable to change a duty cycle of the power switches of the second switching pair and the third switching pair is operable to set a boosted middle voltage across the boost capacitor as a function of a supply voltage and a battery voltage of the battery pack.

12. The converter of claim 11, wherein:
the control processor operable to change the duty cycle of the power switches is configured, when the battery voltage exceeds the supply voltage, to maintain a power switch of the third switching pair in an ON state such that the middle voltage is equal to the battery voltage.

13. An electrical circuit for charging a battery pack, comprising:
a voltage rectifier connectable to an alternating current (AC) voltage supply, the voltage rectifier being configured to rectify an AC input waveform from the AC voltage supply to thereby produce a direct current (DC) output waveform; and
a direct current-to-direct current (DC-DC) converter connected to the voltage rectifier, including:
an output node;
a first power module having four power switches arranged as an H-bridge; and
a second power module connected to the first power module and configured to boost an output voltage level thereof, the second power module including:
first, second, and third switching pairs of power switches, wherein the second switching pair and the third switching pair are connected in parallel;
a boost capacitor arranged in parallel with the second switching pair and the third switching pair; and
a bypass connection that directly connects a power switch of the first switching pair to the battery pack via the output node.

14. The electrical circuit of claim 13, further comprising:
a transformer; and
an inductor-capacitor (LC) circuit, wherein the first power module is the first power module is connected to the second power module via the transformer and the LC circuit.

15. The electrical circuit of claim 14, wherein the four power switches of the first power module and four of the power switches of the second power module form a dual active bridge (DAB) having eight power switches, the electrical circuit further comprising:
a first control processor operable to control a corresponding conductive state of the eight power switches and a state of the isolation circuit using respective control processes, wherein the respective control processes include single phase-shift control and variable frequency control; and
a second control processor operable to change a duty cycle of the power switches of the third switching pair.

16. The electrical circuit of claim 13, wherein a voltage rating of power switches of the second switching pair and the third switching pair exceeds a voltage rating of the power switches of the first switching pair.

17. The electrical circuit of claim 16, wherein the power switches of the second switching pair and the third switching pair are silicon carbide (SiC) switches.

18. A power module comprising:
an output node;
three switching pairs, including a first switching pair, a second switching pair, and a third switching pair, wherein the second switching pair and the third switching pair are connected in parallel, and wherein
a voltage rating of power switches of the second switching pair and the third switching pair exceeds a voltage rating of power switches of the first switching pair;
a boost capacitor arranged in parallel with the second switching pair and the third switching pair;
a bypass connection that directly connects a power switch of the first switching pair to a battery pack via an output node; and
a control processor configured to control a state of the power switches of the three switching pairs.

19. The power module of claim 18, wherein:
the control processor is operable to selectively maintain a power switch of the third switching pair in an ON conducting state.

20. The power module of claim 18, wherein the power switches of the first switching pair and the second switching pair include silicon carbide (SiC) power switches.
